(19) United States
(12) Patent Application Publication
(10) Pub. No.: US 2022/0337672 A1
(43) Pub. Date: Oct. 20, 2022

(54) INFORMATION PROCESSING SYSTEM, CLIENT DEVICE, AND INFORMATION PROCESSING METHOD

(71) Applicant: TOSHIBA TEC KABUSHIKI KAISHA, Tokyo (JP)

(72) Inventor: Ryotaro KOBAYASHI, Izunokuni Shizuoka (JP)

(73) Assignee: TOSHIBA TEC KABUSHIKI KAISHA, Tokyo (JP)

(21) Appl. No.: 17/574,955

(22) Filed: Jan. 13, 2022

(30) Foreign Application Priority Data
Apr. 15, 2021 (JP) 2021-068892

(51) Int. Cl. H04L 67/01; G06Q 30/06; G06Q 20/32; H04W 84/10

(52) U.S. Cl. CPC H04L 67/42; G06Q 30/0641; G06Q 20/322; H04W 84/10; G06Q 30/0633

(57) ABSTRACT

A client device provides first requests for a first server to perform first information processes. The first server performs the first information processes and records first performance results and a history of the first requests in association with an identifier. In response to determining that a failure has occurred regarding the first server, the client device (a) uses the history to identify an incomplete information process that was not completed by the first server and (b) provides a second request for the second server to perform the incomplete information process, the second request including the identifier. The second server performs the incomplete information process and records a second performance result of the incomplete information process in association with the identifier. The second server provides the second performance result and the identifier to the first server. The first server records the second performance result in association with the identifier.

### CROSS-REFERENCE TO RELATED APPLICATION

This application is based upon and claims the benefit of priority from Japanese Patent Application No. 2021-068892, filed on Apr. 15, 2021, the entire contents of which are incorporated herein by reference.

### FIELD

Embodiments described herein relate generally to an information processing system, a client device, and an information processing method.

### BACKGROUND

A system that uses a smartphone possessed by a customer who shops in a store, a tablet terminal provided by the store for the customer, or the like, as a user interface device to perform an information process such as registration of merchandises to be purchased and settlement of prices thereof by a cloud server is known. That is, a system that manages merchandise sales by a client server system including a client device using the smartphone, the tablet terminal, or the like and a server such as a cloud server is known. However, in such a system, if some kind of failure occurs, such as a communication failure between the client device and the server, the subsequent processes cannot be continued, and the customer cannot finish shopping.

Therefore, it is considered to prepare first and second servers and take over the processing by the second server if a failure occurs in the first server. However, in this case, cooperation between the first server and the second server is required, and thus the processing load increases. Under these circumstances, it is desired to be able to easily switch servers if a failure occurs.

### DESCRIPTION OF THE DRAWINGS

FIG. 1 is a block diagram illustrating a schematic configuration of a merchandise sales processing system according to an embodiment;

FIG. 2 is a block diagram illustrating a main circuit configuration of a store server illustrated in FIG. 1;

FIG. 3 is a schematic diagram illustrating a data structure of transaction data illustrated in FIG. 2;

FIG. 4 is a block diagram illustrating a main circuit configuration of a user terminal illustrated in FIG. 1;

FIG. 5 is a schematic diagram illustrating a data structure of history data illustrated in FIG. 4;

FIG. 6 is a block diagram illustrating a main circuit configuration of a cart terminal illustrated in FIG. 1;

FIG. 7 is a block diagram illustrating a main circuit configuration of a cloud server illustrated in FIG. 1;

FIG. 8 is a schematic diagram illustrating a data structure of transaction data illustrated in FIG. 7;

FIG. 9 is a flowchart of an information process based on a smartphone point-of-sale (POS) app by a processor illustrated in FIG. 4;

FIG. 10 is a flowchart of the information process based on the smartphone POS app by the processor illustrated in FIG. 4;

FIG. 11 is a flowchart of a web POS process based on a web POS app by a processor illustrated in FIG. 7; and

FIG. 12 is a flowchart of a proxy POS process based on a proxy POS app by a processor illustrated in FIG. 2.

### DETAILED DESCRIPTION

An object to be solved by exemplary embodiments is to provide an information processing system, a client device, and an information processing method in which servers can be easily switched if a failure occurs.

In general, according to one embodiment, an information processing system includes a first server, a second server, and a client device. The client device is configured to provide a plurality of first requests to the first server, each first request indicating that the first server should perform a first information process. The first server is configured to perform the first information processes according to the first requests from the client device and record a first performance result of each first information process in association with an identifier, the identifier being the same for each first performance result. The client device is configured to record a history of the first requests in correlation with the identifier. The client device is configured to determine occurrence of a failure regarding the first server. In response to determining that the failure has occurred, the client device is configured to (a) use the history to identify an incomplete information process that the client device requested for the first server to perform but that was not completed by the first server due to the failure and (b) provide a second request to the second server, the second request indicating that the second server should perform the incomplete information process, and the second request including the identifier. The second server is configured to perform the incomplete information process according to the second request from the client device and record a second performance result of the incomplete information process in association with the identifier. The second server is configured to provide a notification to the first server, the notification including the second performance result together with the identifier. In response to receiving the notification, the first server is configured to record the second performance result in association with the identifier.

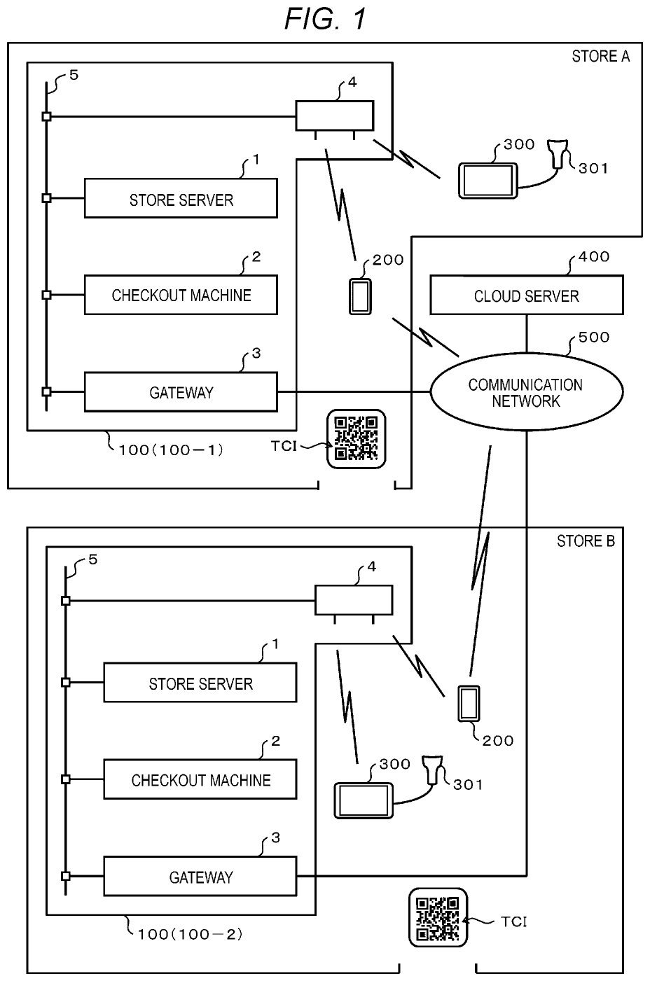

Hereinafter, an embodiment of a merchandise sales processing system configured by applying an information processing system is described with reference to the drawings. FIG. 1 is a block diagram illustrating a schematic configuration of the merchandise sales processing system according to the present embodiment. The merchandise sales processing system includes a plurality of store systems 100, a user terminal 200, a cart terminal 300, and a cloud server 400. Also, the plurality of store systems 100, the user terminal 200, the cart terminal 300, and the cloud server 400 can communicate with each other via a communication network 500.

In FIG. 1, two store systems 100 are illustrated. These store systems 100 are provided in a store A and a store B that both use the merchandise sales processing system but are different from each other. There may be three or more stores using the merchandise sales processing system, and the store system 100 is provided on a per store basis. In the following, if it is required to distinguish the store systems 100 provided in each store, the store system 100 provided in the store A is referred to as the store system 100-1, and the store system 100 provided in the store B is referred to as the store system 100-2. A business operator who operates the store A may be the same as or different from the business operator who operates the store B. If the transaction system is used in the other stores, the business operators who operate the stores may be the same as or different from the business operator who operates the store A or B.

The user terminal 200 and the cart terminal 300 are information processing devices that function as user interfaces for customer who shops by using the merchandise sales processing system in a store. In FIG. 1, one user terminal 200 and one cart terminal 300 are provided in each of the stores A and B, but a plurality of the user terminals 200 and the cart terminals 300 may be provided in each store. In all stores or in some stores, any one of the user terminal 200 and the cart terminal 300 may not be used. The user terminal 200 and the cart terminal 300 include a function of performing wireless communication with the store system 100 and a function of performing wireless communication with the communication network 500. As the user terminal 200, a communication terminal including a data communication function such as a smartphone or a tablet computer can be used. The user terminal 200 may be owned by the customer or may be rented or lent to the customer by the store. As the cart terminal 300, a communication terminal including a data communication function such as a tablet computer is used and attached to a shopping cart provided in the store A or B. The user terminal 200 and the cart terminal 300 are mainly operated by customers. However, the user terminal 200 and the cart terminal 300 may be operated by a clerk or the like on behalf of the customer. The cart terminal 300 includes a barcode scanner 301. The barcode scanner 301 is a reading device (e.g., a reader) suitably configured to optically read a bar code indicating a merchandise code as an identifier for identifying a merchandise by using an infrared laser or the like. As the barcode scanner 301, a reading device configured to recognize and read a barcode from an image photographed by the image capturing device may be provided with instead of or in addition to the reading device.

The cloud server 400 performs an information process for a merchandise sales process such as registration of the merchandises to be purchased and the settlement of the prices thereof according to the request from the user terminal 200 and the cart terminal 300. For example, the cloud server 400 includes a function of performing various information processes for the merchandise sales process and publishes a plurality of application programing interfaces (API) for receiving requests for performing the information processes. In API, a basic uniform resource locator (URL) for specifying the API, a definition regarding an argument to be added to the basic URL, and the like are determined. Also, if an access by an access URL configured by adding the argument or the like to the basic URL is received, the cloud server 400 performs the information process specified by the access URL.

As the communication network 500, for example, the Internet, a virtual private network (VPN), a local area network (LAN), a public communication network, a mobile communication network, and the like can be used by itself or in combination as appropriate. As the communication network 500, a mobile communication network and the Internet are typically used. That is, the communication network 500 is typically a wide area network.

The schematic configuration of each store system 100 is common. That is, in the store system 100, a store server 1, a checkout machine 2, a gateway 3, and an access point 4 are communicably configured (e.g., operatively coupled) via an in-store communication network 5. However, the store server 1, the checkout machine 2, the gateway 3, the access point 4, and the in-store communication network 5 may have common functions for realizing the operations described below and do not have to be completely the same. Some store systems 100 may include devices that are not illustrated in FIG. 1.

The store server 1 performs an information process for the merchandise sales process such as the registration of the merchandise to be purchased and the settlement of the prices thereof according to the request from the user terminal 200 and the cart terminal 300. The store server 1 includes functions of performing the same information process as those performed by the cloud server 400 for the merchandise sales process. The store server 1 also publishes APIs for receiving the request for performing the information processes. Regarding the same information process, the basic URLs of the APIs published by the cloud server 400 and the store server 1 respectively are correlated with each other in advance. According to the present embodiment, for example, with respect to the APIs of the process of registering the designated merchandises as the merchandises to be purchased, “xyz.cloud.co.jp/api/registration” and “192.168.1.zzz/api/registration” are determined as basic URLs regarding the cloud server 400 and the store server 1, respectively. That is, only the domain portions of the basic URL determined by the API of the same information process are different. Also, if the access by the access URL is received, the store server 1 performs the information process to be provided by the APIs specified by the access URL. That is, the store server 1 includes a function of performing the same merchandise sales process as the cloud server 400. However, the store server 1 performs these functions in order to temporarily perform the function of the cloud server 400 by proxy as described below. That is, the cloud server 400 corresponds to the first server that actively performs the merchandise sales process and the store server 1 corresponds to the second server that performs the merchandise sales process by proxy. Also, the user terminal 200 and the cart terminal 300 correspond to the client device for using the merchandise sales process by the cloud server 400 or the store server 1. The store server 1 is a local server that is provided in the store that is a facility where the user terminal 200 and the cart terminal 300 as client device are operated.

The checkout machine 2 is a user interface device if the customer performs the settlement in the store. The settlement methods that the checkout machine 2 can use for the above settlement may be all or any part of the well-known settlement methods such as cash settlement, credit card settlement, electronic money settlement, point settlement, and code settlement. The code settlement is also referred to as the mobile settlement, the smartphone settlement, or the like. The checkout machine 2 may be operated by any one of the clerk or the customer. The checkout machine 2 may be configured, for example, based on a self-service-type checkout machine used for a semi-self-service-type point-of-sale (POS) system in the related art. The checkout machine 2 may have a function of performing the information process for registering a merchandise as a merchandise to be purchased. In this case, the checkout machine 2 may be configured, for example, based on a face-to-face POS terminal used in a POS system in the related art or a self-service-type POS terminal used in the self-service-type POS system in the related art.

The gateway 3 interconnects the in-store communication network 5 and the communication network 500 and can perform the communication via both the in-store communication network 5 and the communication network 500. As the gateway 3, for example, the communication device in the related art that interfaces the LAN and the Internet can be used.

The access point 4 performs the communication process for enabling the user terminal 200 to access the in-store communication network 5 by the wireless communication. As the access point 4, for example, a well-known communication device that performs the wireless communication by the IEEE 802.11 standard can be used. The access point 4 is installed in a store so that the user terminal 200 can perform wireless communication from anywhere on the sales floor of the store. Depending on the scale of the store, the plurality of access points 4 may be disposed in one store system 100.

As the in-store communication network 5, the Internet, VPN, LAN, the public communication network, the mobile communication network, and the like can be used by itself or in combination as appropriate. However, generally, the in-store communication network 5 is LAN. That is, generally, the in-store communication network 5 is a narrow area network.

In the store where the store system 100 is provided, a two-dimensional code TCI for check-in is posted near the entrance. The two-dimensional code TCI indicates check-in data for check-in. The check-in data is different on a per store basis. For example, the check-in data indicates information such as (1) an operation version of the store system 100, (2) a store code for identifying the store, (3) a name of a business operator who operates the store, (4) a name of the store provided with the store system 100, (5) a business operator code for identifying the business operator who operates the store, and (6) a connection destination for communicating with the store system 100 by the user terminal 200 or information required for the connection, for each store. Examples of the connection destination for communicating with the store system 100 by the user terminal 200 include the access point 4. Examples of the information required for the connection include a service set identifier (SSID) for identifying the access point 4, a password for accessing the access point 4, and the like. Examples of the information required for the connection also include a domain name of the store server 1. The check-in data may not include a part of the various kinds of exemplified information. The check-in data may indicate information different from the various kinds of exemplified information.

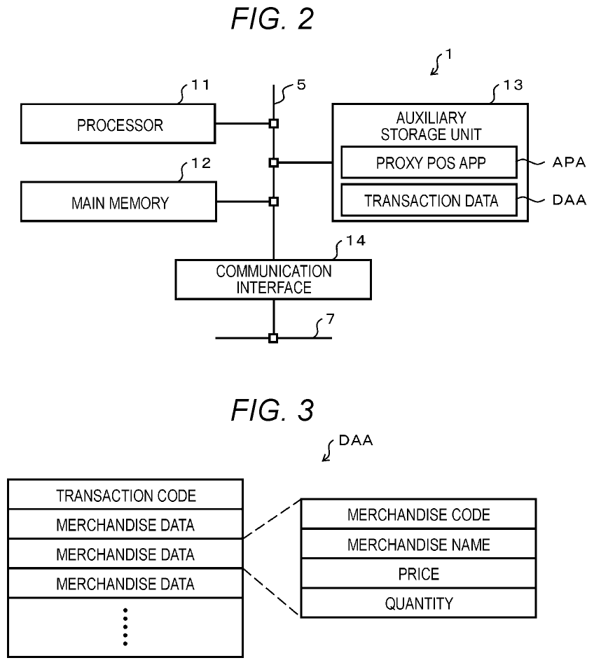

FIG. 2 is a block diagram illustrating a main circuit configuration of the store server 1. The store server 1 includes a processor 11, a main memory 12, an auxiliary storage unit 13, a communication interface 14, and a transmission line 15. The processor 11, the main memory 12, the auxiliary storage unit 13, and the communication interface 14 can communicate with each other via the transmission line 15. Also, the processor 11, the main memory 12, and the auxiliary storage unit 13 are connected to each other through the transmission line 15, to configure a computer (e.g., a controller, a processing circuit, etc.) for controlling the store server 1.

The processor 11 corresponds to a central portion of the computer. The processor 11 performs an information process for realizing various functions as the store server 1 according to an operating system and an information processing program such as an application program. The processor 11 is, for example, a central processing unit (CPU).

The main memory 12 corresponds to the main storage portion of the computer. The main memory 12 includes a non-volatile memory area and a volatile memory area. The main memory 12 stores the information processing program in the non-volatile memory area. The main memory 12 may store data required for performing the information process by the processor 11 in the non-volatile or volatile memory area. The main memory 12 uses the volatile memory area as a work area in which data is appropriately rewritten by the processor 11. The non-volatile memory area is, for example, a read only memory (ROM). The volatile memory area is, for example, a random access memory (RAM).

The auxiliary storage unit 13 corresponds to an auxiliary storage portion of the computer. As the auxiliary storage unit 13, for example, storage units using well-known storage devices such as an electric erasable programmable read-only memory (EEPROM), a hard disc drive (HDD), or a solid state drive (SSD) can be used. The auxiliary storage unit 13 stores data used for performing various processes by the processor 11, data generated by the process in the processor 11, or the like. The auxiliary storage unit 13 may store the above information processing program.

The communication interface 14 performs data communication with each unit connected to the in-store communication network 5 according to a predetermined communication protocol. As the communication interface 14, for example, a well-known communication device for the LAN can be applied. The transmission line 15 includes an address bus, a data bus, a control signal line, and the like, and transmits data and control signals to be transmitted and received to and from the connected each of the units.

The auxiliary storage unit 13 stores a proxy POS app APA that is one of the information processing programs. The proxy POS app APA is an application program, and the information process for realizing the functions as the store server 1 is described therein. A part of the storage area of the auxiliary storage unit 13 is used for storing transaction data DAA. The transaction data DAA is a collection of various kinds of data for managing one transaction regarding the merchandise sales in the store.

FIG. 3 is a schematic diagram illustrating the data structure of the transaction data DAA. The transaction data DAA includes merchandise data regarding registered merchandises as the merchandises to be purchased, in correlation with the transaction code as the identifier of the transaction. Accordingly, how many pieces of the merchandise data the transaction data DAA includes depends on the number of the registered merchandises as the merchandises to be purchased. The merchandise data includes the merchandise codes, the merchandise names, the prices, the quantities, and the like. The merchandise code is an identifier determined for identifying the corresponding merchandises on a per stock keeping unit (SKU) basis, and for example, a Japanese article number (JAN) code is used. The merchandise name is a name determined so that the corresponding merchandise is easily distinguished by a human. The price is an amount of money for the sales of the corresponding merchandise. The quantity is the purchased quantity of the corresponding merchandise.

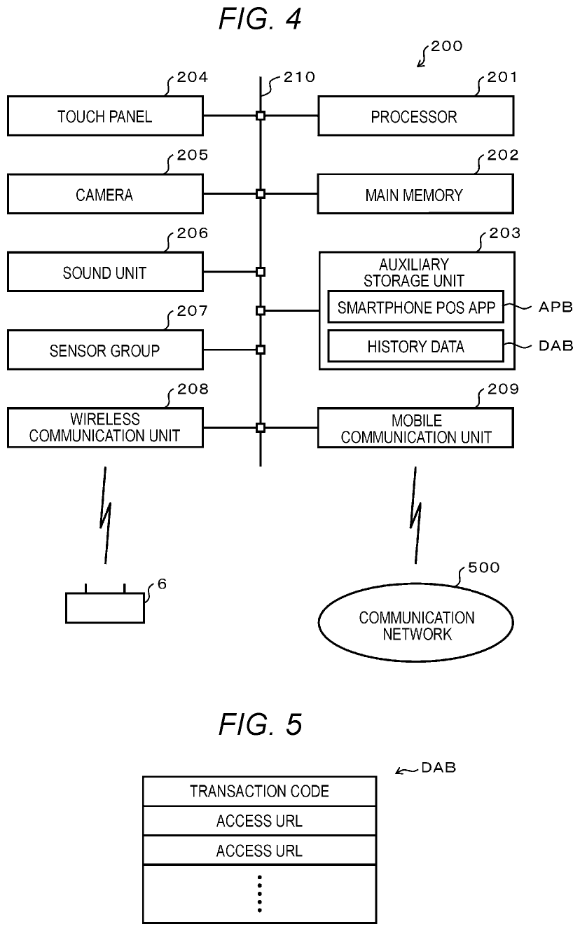

FIG. 4 is a block diagram illustrating a main circuit configuration of the user terminal 200. The user terminal 200 includes a processor 201, a main memory 202, an auxiliary storage unit 203, a touch panel 204, a camera 205, a sound unit 206, a sensor group 207, a wireless communication unit 208, a mobile communication unit 209, a transmission line 210, and the like. The processor 201 can communicate with the main memory 202, the auxiliary storage unit 203, the touch panel 204, the camera 205, the sound unit 206, the sensor group 207, the wireless communication unit 208, and the mobile communication unit 209 via the transmission line 210. Also, the processor 201, the main memory 202, and the auxiliary storage unit 203 are connected to each other through the transmission line 210, to configure a computer (e.g., a controller, a processing circuit, etc.) for controlling the user terminal 200. The schematic functions of the processor 201, the main memory 202, the auxiliary storage unit 203, and the transmission line 210 are the same as those of the processor 11, the main memory 12, the auxiliary storage unit 13, and the transmission line 15, and thus the description thereof is omitted.

The touch panel 204 (e.g., a user interface) functions as an input device and a display device of the user terminal 200. The camera 205 (e.g., image capture device) includes an optical system and an image sensor and the image sensor generates image data that indicates an image in the field of view formed by the optical system. The sound unit 206 (e.g., a speaker) outputs various sounds such as voice and melody. The sensor group 207 (e.g., one or more sensors, a sensor system, etc.) includes various sensors such as an angular velocity sensor and a global positioning system (GPS) sensor.

The wireless communication unit 208 transmits and receives data to and from the access point 4 by wireless communication according to the wireless communication protocol. As the wireless communication unit 208, for example, a well-known communication device can be used in conformity to the IEEE 802.11 standard. The mobile communication unit 209 is an interface of the data communication via the communication network 500. As the mobile communication unit 209, for example, a well-known communication device for performing data communication via a mobile communication network can be used.

The auxiliary storage unit 203 stores a smartphone POS app APB that is one of the information processing programs. The smartphone POS app APB is an application program, and the information process described below that causes the user terminal 200 to function as the user interface for customers of the store system 100 is described therein. A part of the storage area of the auxiliary storage unit 203 is used for storing history data DAB. The history data DAB is data for managing the history of the request made to the cloud server 400 regarding one transaction.

FIG. 5 is a schematic diagram illustrating the data structure of the history data DAB. The history data DAB includes an access URL used to request the cloud server 400 to perform the information process regarding the transaction identified by the corresponding transaction code in correlation with the transaction code. Accordingly, how many access URLs the history data DAB includes depends on the number of times of the request.

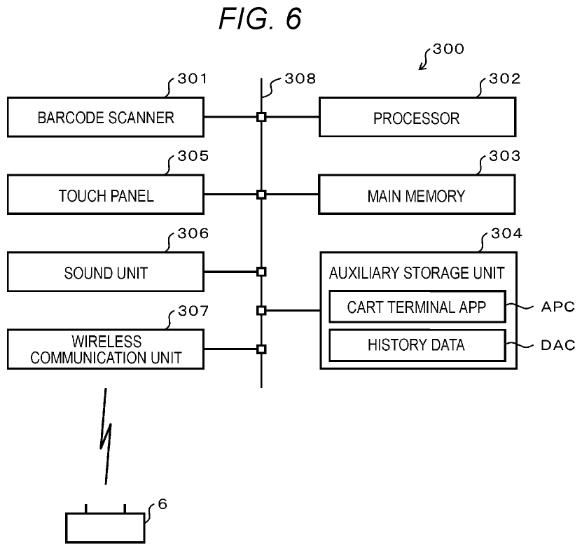

FIG. 6 is a block diagram illustrating a main circuit configuration of the cart terminal 300. In addition to the barcode scanner 301, the cart terminal 300 includes a processor 302, a main memory 303, an auxiliary storage unit 304, a touch panel 305, a sound unit 306, a wireless communication unit 307, a transmission line 308, and the like. The processor 302 can communicate with the barcode scanner 301, the main memory 303, the auxiliary storage unit 304, the touch panel 305, the sound unit 306, and the wireless communication unit 307 via the transmission line 308. Also, the processor 302, the main memory 303, and the auxiliary storage unit 304 are connected to each other through the transmission line 308, to configure a computer for controlling the cart terminal 300. The schematic functions of the processor 302, the main memory 303, the auxiliary storage unit 304, the touch panel 305, the sound unit 306, the wireless communication unit 307, and the transmission line 308 are the same as those of the processor 11, the main memory 12, the auxiliary storage unit 13, the touch panel 204, the sound unit 206, and the wireless communication unit 208, and the transmission line 15, and thus the description thereof is omitted.

The auxiliary storage unit 304 stores a cart terminal app APC that is one of the information processing programs. The cart terminal app APC is an application program, and the information process for causing the cart terminal 300 to function as a user interface for customers of the store system 100 is described therein. A part of the storage area of the auxiliary storage unit 304 is used to store history data DAC. The history data DAC is data for managing the history of the request made to the cloud server 400 regarding one transaction. The history data DAC may have, for example, the same configuration as the history data DAB.

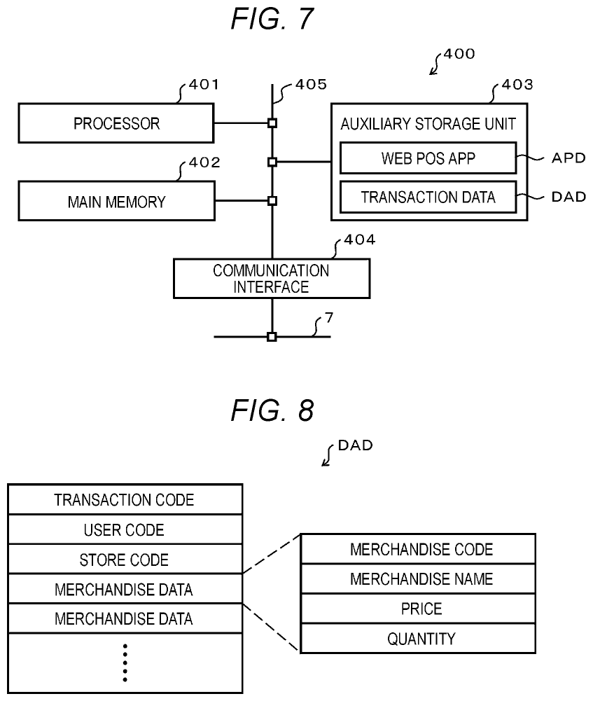

FIG. 7 is a block diagram illustrating the main circuit configuration of the cloud server 400. The cloud server 400 includes a processor 401, a main memory 402, an auxiliary storage unit 403, a communication interface 404, and a transmission line 405. The processor 401, the main memory 402, the auxiliary storage unit 403, and the communication interface 404 can communicate with each other via the transmission line 405. Also, the processor 401, the main memory 402, and the auxiliary storage unit 403 are connected to each other through the transmission line 405, to configure a computer for controlling the cloud server 400. In addition, schematic functions of the processor 401, the main memory 402, the auxiliary storage unit 403, the communication interface 404, and the transmission line 405 are the same as those of the processor 11, the main memory 12, the auxiliary storage unit 13, the communication interface 14, and the transmission line 15, and thus the description thereof is omitted.

The auxiliary storage unit 403 stores a web POS app APD that is one of the information processing programs. The web POS app APD is an application program, and the information process described below for providing the service described below is described therein. A part of the storage area of the auxiliary storage unit 403 is used to store transaction data DAD. The transaction data DAD is a collection of various kinds of data for managing one transaction. The auxiliary storage unit 403 may store the plurality of pieces of the transaction data DAD regarding each of the plurality of transactions processed in parallel.

FIG. 8 is a schematic diagram illustrating the data structure of the transaction data DAD. The transaction data DAD includes user codes, store codes, and merchandise data in correlation with the transaction code. The transaction code is an identifier of the transaction correlated with the corresponding transaction data DAD. The user code is an identifier of the customer of the transaction correlated with the corresponding transaction data DAD. The store code is an identifier of the store where the transaction correlated with the corresponding transaction data DAD is performed. The merchandise data is data for managing the registered merchandise as the merchandise to be purchased. The transaction data DAD includes none of the merchandise data in a state in which there is no registered merchandise as the merchandise to be purchased. In the state in which a plurality of merchandises are registered as the merchandises to be purchased, the transaction data DAD includes a plurality of pieces of the merchandise data regarding each of the merchandises to be purchased. The merchandise data includes the merchandise codes, the merchandise names, the prices, the quantities, and the like.

In the store server 1, the user terminal 200, the cart terminal 300, or the cloud server 400, the proxy POS app APA, the smartphone POS app APB, the cart terminal app APC, or the web POS app APD may be transferred in a state of being stored in the auxiliary storage units 13, 203, 304, and 403, and hardware in a state of not storing the proxy POS app APA, the smartphone POS app APB, the cart terminal app APC, or the web POS app APD in the auxiliary storage units 13, 203, 304, and 403, and the proxy POS app APA, the smartphone POS app APB, the cart terminal app APC, or the web POS app APD may be individually transferred. The proxy POS app APA, the smartphone POS app APB, the cart terminal app APC, or the web POS app APD can be transferred by being recorded in a removable recording medium such as magnetic disks, magneto-optical disks, optical disks, and semiconductor memories or by communication via a network.

Subsequently, an operation of the merchandise sales processing system configured as described above is described. Contents of the various kinds of processes described below are examples, and a change of an order of some processes, omission of some processes, or addition of other processes can be appropriately performed. In the following description, for example, for easier understanding of characteristic operations of the present embodiment, description of some processes is omitted. For example, if some errors occur, a process for dealing with the errors may be performed, but description of such a processes is omitted.

A service provided to the customer by the operation of the merchandise sales processing system described below is referred to as a smartphone POS service, a cart POS service, or the like, but in the following, the service is referred to as a smartphone POS service. Also, in the following, operations for realizing shopping using the user terminal 200 are mainly described.

In order to use the smartphone POS service, the customer can install the smartphone POS app APB on a smartphone or the like owned by the customer to use the smartphone as the user terminal 200. Otherwise, the customer rents the user terminal 200 configured by installing the smartphone POS app APB in a tablet computer or the like from the store. Also, prior to entering the store, the customer starts the information process based on the smartphone POS app APB.

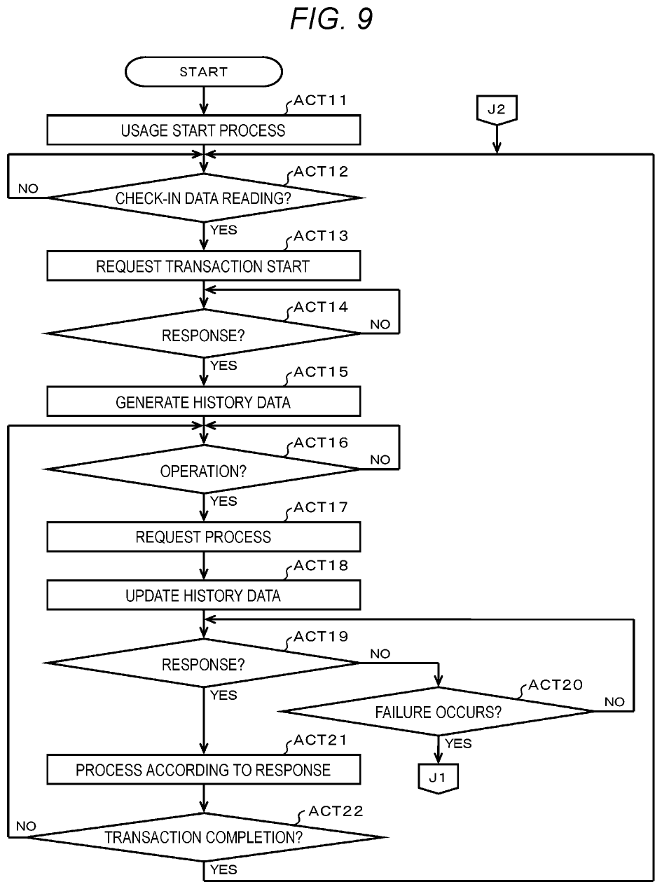

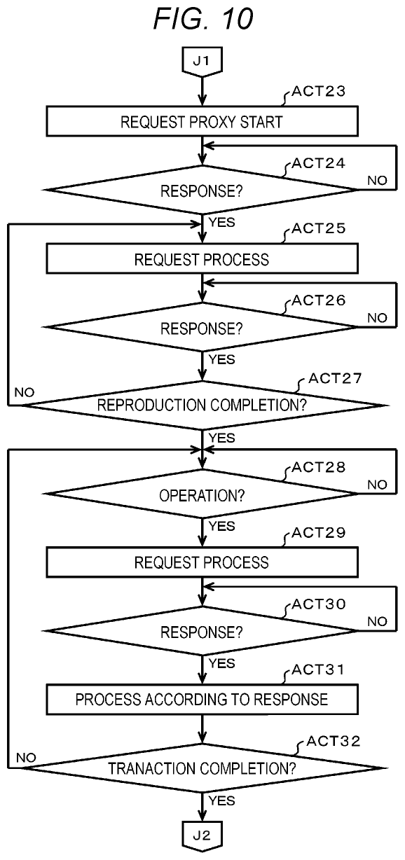

FIGS. 9 and 10 are flowcharts of the information process based on the smartphone POS app APB by the processor 201. First, in ACT 11 illustrated in FIG. 9, the processor 201 performs a usage start process for starting use of the smartphone POS service. Details of the usage start processes are not necessary to describe the present embodiment, and thus the description thereof is omitted. The usage start process may be the same process as that performed when starting the smartphone application, for example, for using the cloud service. For example, the processor 201 performs the process for receiving the user authentication by the cloud server 400 as one process of the usage start processes. For example, the processor 201 starts the camera 205 as one process of the usage start processes and displays a scanning screen for prompting the customer to photograph the two-dimensional code TCI with the camera 205, on the touch panel 204.

In the cloud server 400, if an access from the user terminal 200 is made with performing the usage start process, the processor 401 starts the information process according to the web POS app APD (hereinafter, referred to as a web POS process) in order to provide the smartphone POS service to the corresponding user terminal 200. If the web POS process is already performed using another user terminal 200 as a target, the processor 401 starts a new web POS process in parallel with the web POS process. That is, the processor 401 may perform a plurality of web POS processes in parallel using a plurality of user terminals 200 as targets, respectively. Hereinafter, if “the user terminal 200” is simply used, the expression indicates the user terminal 200 to be a target of the web POS process in the description.

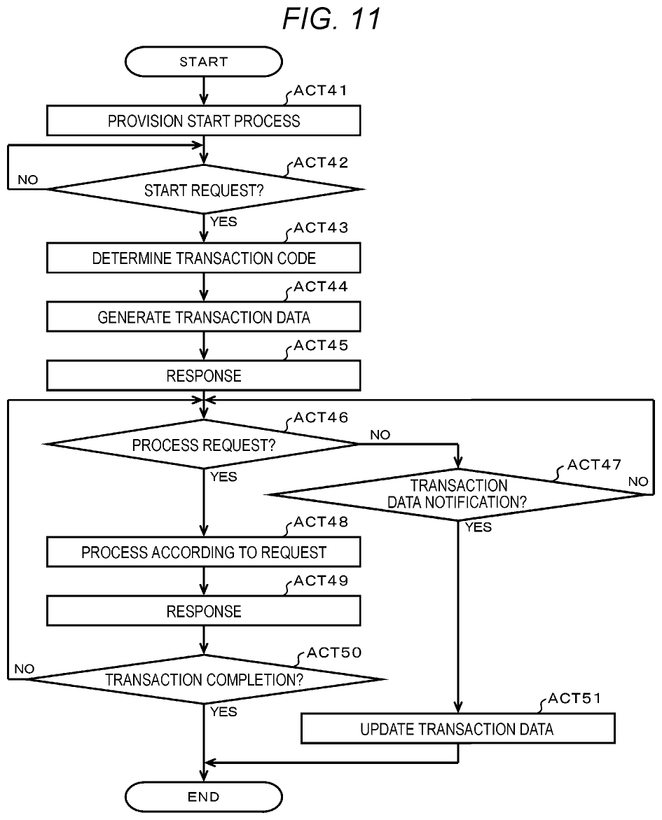

FIG. 11 is a flowchart of the web POS process based on the web POS app APD by the processor 401. In ACT 41, the processor 401 performs the provision start process for starting the provision of the smartphone POS service to the accessing user terminal 200. Details of the provision start process are not necessary to describe the present embodiment, and thus the description thereof is omitted. The type of process that is performed as the provision start process may be determined in any way, for example, by the developer of the web POS app APD. In addition, the provision start process may be the same process as that performed if the smartphone application for using the cloud service starts, for example. For example, the processor 401 performs the process for authenticating the customer using the smartphone POS service as one process of the provision start processes in cooperation with the usage start process described above in the user terminal 200.

The customer possesses the user terminal 200 and enters any store provided with the store system 100. At this point, the customer photographs the two-dimensional code TCI with the camera 205 of the user terminal 200 so that the check-in data indicated by the corresponding two-dimensional code TCI is read by the user terminal 200.

If the usage start process in ACT 11 in FIG. 9 ends, the processor 201 proceeds to ACT 12. In ACT 12, the processor 201 waits for the reading of the check-in data. If the check-in data is read by photographing the two-dimensional code TCI with the camera 205, the processor 201 determines YES and proceeds to ACT 13.

In ACT 13, the processor 201 requests the start of the transaction from the cloud server 400. The processor 201 performs various requests on the cloud server 400 described below including the request here, by accessing the cloud server 400 by using an access URL generated by adding the argument defined on a per API basis to the basic URL of the API published in order to receive these requests. However, some requests such as the start request of the transaction may be performed without using an API.

For example, if the basic URL of the API regarding the process for starting the transaction is determined as “xyz.cloud.co.jp/api/start”, the processor 201 generates the access URL by adding a store code or the like indicated in the check-in data as the argument and accesses the cloud server 400 from the mobile communication unit 209 via the communication network 500 by the access URL.

In the cloud server 400, if the provision start process in ACT 41 in FIG. 11 ends, the processor 401 proceeds to ACT 42. In ACT 42, the processor 401 waits for the start request from the user terminal 200. Also, if the access by the access URL for the start request as described above is received from the user terminal 200 via the communication network 500, the processor 401 determines YES and proceeds to ACT 43.

In ACT 43, the processor 401 determines the transaction code for identifying the transaction that starts according to the start request. For example, according to a predetermined rule, the processor 401 determines a code different from the transaction code for identifying the other transaction as a new transaction code.

In ACT 44, the processor 401 generates the transaction data DAD correlated with the transaction to be started and stores the transaction data DAD in the auxiliary storage unit 403. If the transaction data DAD generated by another web POS process performed in parallel is already stored in the auxiliary storage unit 403, the processor 401 keeps the transaction data DAD as it is and stores the transaction data DAD newly generated here in the auxiliary storage unit 403. The processor 401 includes a transaction code determined in ACT 43, a user code acquired in the provision start process in ACT 41, and a store code included in the access URL for the start request as the argument, in the transaction data DAD to be generated here. In this step, the processor 401 does not include merchandise data in the transaction data DAD. In ACT 45, the processor 401 responds to the start request. For example, the processor 401 transmits the predetermined response data to the user terminal 200 via the communication network 500. The processor 401 includes the transaction code determined in ACT 43, in the response data.

In the user terminal 200, the processor 201 requests the transaction start in ACT 13 in FIG. 9, and then proceeds to ACT 14. In ACT 14, the processor 201 waits for a response to the request. Also, if the response data transmitted from the cloud server 400 as described above is received by the mobile communication unit 209, the processor 201 determines YES and proceeds to ACT 15. In ACT 15, the processor 201 generates the history data DAB. For example, the processor 201 includes the transaction code included in the response data, generates the history data DAB as data that does not include an access URL, and stores the history data DAB in the auxiliary storage unit 203.

If the merchandise is registered as the merchandise to be purchased, the customer inputs the merchandise code of the merchandise to the user terminal 200. For example, the customer causes the camera 205 to read the barcode indicating the merchandise code displayed on the merchandise. Otherwise, for example, the customer touches a button displayed on the touch panel 204 and correlated with the merchandise code. Otherwise, for example, the customer operates the touch panel 204 and manually inputs the merchandise code. When changing the quantity of the registered merchandise as the merchandise to be purchased, the customer performs a predetermined operation, for example, on the touch panel 204. If the customer wants to exclude the registered merchandise as the merchandise to be purchased from the merchandises to be purchased, the customer performs a predetermined operation, for example, on the touch panel 204. If the customer wants to end the registration of the merchandises to be purchased and settle the prices of the merchandises to be purchased, the customer performs a predetermined operation for instructing the settlement on the touch panel 204. The customer performs another predetermined operation.

In ACT 16, the processor 201 waits for the operation as described above, by the customer. What kind of operation the processor 201 waits for here may be appropriately determined, for example, by the developer of the web POS app APD. Then, if any one operation to be received is performed, the processor 201 determines YES and proceeds to ACT 17.

In ACT 17, the processor 201 requests the process according to the operation from the cloud server 400. For example, if the registration of the merchandise to be purchased is requested, the processor 201 accesses the cloud server 400 by using the access URL generated, for example, by adding the merchandise code or the like as the argument to the basic URL of the API published for the registration request. For example, if the change of the quantity of the merchandise to be purchased is requested, the processor 201 accesses the cloud server 400 by using the access URL generated, for example, by adding the merchandise code and the changed quantity as the argument to the basic URL of the API published for the quantity change request. If the exclusion of the merchandise to be purchased is requested, the processor 201 accesses the cloud server 400 by using the access URL generated, for example, by adding the merchandise code or the like as the argument to the basic URL of the API published for the exclusion request. For example, if the settlement is requested, the processor 201 accesses the cloud server 400 by using the access URL generated, for example, by adding the settlement data indicating the settlement method to be applied, as the argument, to the basic URL of the API published for the settlement request. That is, the processor 201 performs the information process based on the smartphone POS app APB, and thus the computer including the processor 201 as the central portion functions as a first request unit. In ACT 18, the processor 201 updates the history data DAB stored in the auxiliary storage unit 203 to include an access URL used for the request in ACT 17.

In the cloud server 400, the processor 401 responds in ACT 45 in FIG. 11, and then proceeds to ACT 46. In ACT 46, the processor 401 confirms whether the process is requested. Also, if the corresponding event cannot be confirmed, the processor 401 determines NO and proceeds to ACT 47. In ACT 47, the processor 401 confirms whether the transaction data is notified. Also, if the corresponding event cannot be confirmed, the processor 401 determines NO and returns to ACT 46. Therefore, the processor 401 waits for the request of the process or the notification of the transaction data in ACTS 46 and 47.

If the access by the access URL is performed as described above, the processor 401 determines YES in ACT 46 and proceeds to ACT 48. In ACT 48, the processor 401 performs the process according to the request. If the access by the access URL for the registration request is received, the processor 401 adds the merchandise data including the merchandise code included in the access URL as the argument to the transaction data DAD stored in the auxiliary storage unit 403. For example, if the access by the access URL for the quantity change request is received, the processor 401 finds the merchandise data including the merchandise code included in the access URL as the argument from the transaction data DAD stored in the auxiliary storage unit 403 and changes the quantity included in the corresponding merchandise data to the quantity included in the access URL as the argument. For example, if the access by the access URL for the exclusion request is received, the processor 401 finds the merchandise data including the merchandise code included in the access URL as the argument from the transaction data DAD stored in the auxiliary storage unit 403 and deletes the corresponding merchandise data from the transaction data DAD. For example, if the access by the access URL for the settlement request is received, the processor 401 calculates the prices of the merchandises to be purchased based on the transaction data DAD stored in the auxiliary storage unit 403 and performs the process predetermined for settling the corresponding price by the settlement method indicated by the settlement data included in the access URL as the argument. However, these processes are examples, and the other processes may be performed for the same request. In addition, by updating the transaction data DAD by the above process, the processor 401 manages performance results of a plurality of processes in correlation with one transaction identifier by using the transaction data DAD. Therefore, the processor 401 performs the information process based on the web POS app APD, and thus a computer including the processor 401 as the central portion functions as a first processing unit and a second management unit.

In ACT 49, the processor 401 responds to the request received this time. The processor 401 transmits, for example, response data including the data of the screen indicating the content of the changed transaction data to the user terminal 200 via the communication network 500. For example, if the transaction completion state predetermined by the process in ACT 48 is set, the processor 401 includes notification data predetermined for notifying the completion of the transaction in response data. What kind of state is set as the transaction completion state may be determined in any way, for example, by the developer of the web POS app APD. For example, it is assumed that the state in which the settlement is completed is determined as the transaction completion state.

In ACT 50, the processor 401 confirms whether the transaction is completed, by the process performed in ACT 48. Also, if the transaction is not completed, the processor 401 determines NO and returns to the waiting state of ACTS 46 and 47. However, if the transaction is completed, for example, if the settlement normally ends in ACT 48, the processor 401 determines YES in ACT 50 and ends the web POS process.

In the user terminal 200, the processor 201 updates the history data DAB in ACT 18 in FIG. 9, and then proceeds to ACT 19. In ACT 19, the processor 201 confirms whether the response to the process requested in ACT 17 is performed. Also, if the corresponding event cannot be confirmed, the processor 201 determines NO and proceeds to ACT 20. In ACT 20, the processor 201 confirms whether the failure occurs. Also, if the corresponding event cannot be confirmed, the processor 201 determines NO and returns to ACT 19. Therefore, the processor 201 waits for the response or the occurrence of the failure in ACTS 19 and 20. Also, the response data transmitted from the cloud server 400 is received by the mobile communication unit 209 as described above, the processor 201 determines YES in ACT 19 and proceeds to ACT 21.

In ACT 21, the processor 201 performs the process according to the response from the cloud server 400. For example, if the response data including the data of the screen indicating the content of the changed transaction data is received as described above, the processor 201 displays the corresponding screen on the touch panel 204.

In ACT 22, the processor 201 confirms whether the transaction is completed. Also, for example, if the notification data for notifying the transaction completion is not included in the response data, the processor 201 determines NO and returns to the waiting state of ACT 16. That is, the processor 201 continuously waits for a new operation. Also, the processor 201 repeatedly performs ACTS 17 to 21 according to the new operation. That is, whenever a new process is requested, the processor 201 adds the access URL used for the request to the history data DAB. The processor 201 updates the history data DAB so that access orders of each access URL are expressed according to the description order of each access URL in the history data DAB. Therefore, the processor 201 performs the information process based on the smartphone POS app APB, and thus a computer including the processor 201 as the central portion functions as a recording unit.

If the communication with the cloud server 400 cannot be continued due to the failure in the communication network 500 or the failure of the cloud server 400, the processor 201 determines YES in ACT 20 and proceeds to ACT 23 in FIG. 10. Therefore, the processor 201 performs the information process based on the smartphone POS app APB, and thus a computer including the processor 201 as the central portion functions as a determination unit.

In ACT 23, the processor 201 requests the start of a proxy for performing the process of the transaction interrupted due to the failure by proxy, from the store server 1. For example, after the communication with the access point 4 is established based on the information required for the connection to the access point 4 indicated in the check-in data, the processor 201 accesses the store server 1 by the access URL including the transaction code as the argument in the basic URL indicated in the check-in data regarding the process for the start of the proxy via the corresponding access point 4 and the in-store communication network 5. As a result, for example, the user terminal 200 existing in the store A accesses the store server 1 included in the store system 100-1. In addition, for example, the user terminal 200 existing in the store B accesses the store server 1 included in the store system 100-2.

In the store server 1, if the access from the user terminal 200 by the access URL for the request of the proxy start process is performed as described above, the processor 11 starts the information process according to the proxy POS app APA (hereinafter, referred to as a proxy POS process) in order to provide the smartphone POS service to the corresponding user terminal 200 by proxy. If the proxy POS process is already performed using another user terminal 200 as a target, the processor 11 starts a new proxy POS process in parallel with the proxy POS process. That is, the processor 11 may perform a plurality of proxy POS processes in parallel using the plurality of user terminals 200 as targets, respectively. Hereinafter, if “the user terminal 200” is simply used, the expression indicates the user terminal 200 to be a target of the proxy POS process in the description.

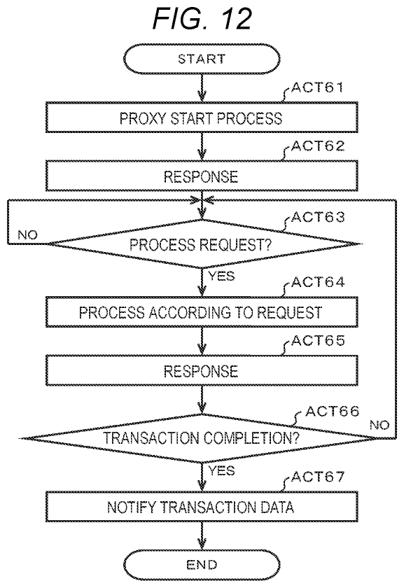

FIG. 12 is a flowchart of the proxy POS process based on the proxy POS app APA by the processor 11. In ACT 61, the processor 11 performs the proxy start process for starting a proxy provision of the smartphone POS service to the accessing user terminal 200. For example, the processor 11 includes the transaction code included in the access URL as the argument, generates the transaction data DAA that does not include merchandise data, and stores the transaction data DAA in the auxiliary storage unit 13. If the transaction data DAA generated by another proxy POS process performed in parallel is already stored in the auxiliary storage unit 13, the processor 11 keeps the transaction data DAA as it is and stores the transaction data DAA newly generated here in the auxiliary storage unit 13. In ACT 62, the processor 11 responds to the start request. For example, the processor 11 transmits the predetermined response data to the user terminal 200 via the communication network 500.

In the user terminal 200, the processor 201 requests the proxy start in ACT 23 in FIG. 10, and then proceeds to ACT 24. In ACT 24, the processor 201 waits for the response to the request. Also, if the response data transmitted from the store server 1 is received by the mobile communication unit 209 as described above, the processor 201 determines YES and proceeds to ACT 25.

In ACT 25, the processor 201 requests the process from the store server 1 based on the history data DAB. For example, the processor 201 selects the access URL used for the oldest access included in the history data DAB and accesses the store server 1 by the access URL obtained by substituting a domain portion of the access URL with the domain indicated in the check-in data. That is, if the access URL selected from the history data DAB is “xyz.cloud.co.jp/api/registration/4946843523221”, and the domain indicated in the check-in data is “192.168.1.zzz”, the processor 201 accesses the store server 1 by the access URL set as “192.168.1.zzz/api/registration/4946843523221”.

In the store server 1, after the response in ACT 62 in FIG. 12, the processor 11 proceeds to ACT 63. In ACT 63, the processor 11 waits for the request of the process. Also, if the access by the access URL as described above is made, the processor 11 determines YES in ACT 63 and proceeds to ACT 64.

In ACT 64, the processor 11 performs the process according to the request. For example, the processor 11 performs the information process in the same manner as performed by the processor 401 of the cloud server 400 in ACT 48 in FIG. 11. However, the processor 11 updates the transaction data using the transaction data DAA stored in the auxiliary storage unit 13 as the target. In ACT 65, the processor 11 responds to the request received this time. For example, the processor 11 responds to the user terminal 200 in the same manner as performed by the processor 401 of the cloud server 400 in ACT 49 in FIG. 11. In ACT 66, the processor 11 confirms whether the transaction is completed, by the process performed in ACT 64. Also, if the transaction is not completed, the processor 11 determines NO and returns to the waiting state of ACT 63.

In the user terminal 200, the processor 201 updates the history data DAB in ACT 25 in FIG. 10, and then proceeds to ACT 26. In ACT 26, the processor 201 waits for the response to the process requested in ACT 25. Also, if the response data transmitted from the store server 1 is received by the mobile communication unit 209 as described above, the processor 201 determines YES and proceeds to ACT 27.

In ACT 27, the processor 201 confirms whether the reproduction of the request is completed based on the history data DAB. For example, if ACT 25 is performed immediately before, if the access URL used for the newest access included in the history data DAB is not selected, the processor 201 determines that the reproduction is not completed, determines NO, and repeats ACT 25 and subsequent processes in the same manner as described above. However, at this point, in ACT 25, the processor 201 selects an unselected access URL from the access URLs included in the history data DAB in chronological order. Therefore, the processor 201 requests the process requested from the cloud server 400 by the access URL included in the history data DAB, from the store server 1 in the same manner. Therefore, the processor 201 performs the information process based on the smartphone POS app APB, and thus a computer including the processor 201 as the central portion functions as a second request unit. Accordingly, the processor 201 uses the history data DAB to identify an incomplete information process that the processor 201 requested for the cloud server 400 to perform but that was not completed by the cloud server 400 due to a failure and provides a request to the store server 1 for the store server to perform the incomplete information process.

In the store server 1, if the processes requested from the cloud server 400 are sequentially requested as described above, the processor 11 is in the waiting state of ACT 63 in FIG. 12. Therefore, the processor 11 repeats ACTS 64 and 65 whenever the process is requested.

As described above, the user terminal 200 requests the process from the store server 1 again, based on the history data DAB, and the processor 11 performs the process according to the request in the store server 1, and thus the transaction data DAA is generated including the merchandise data in the auxiliary storage unit 13 of the store server 1 in the same manner as the transaction data DAD stored in the auxiliary storage unit 403 of the cloud server 400 if the failure occurs.

In the user terminal 200, while the processor 201 requests the process requested from the cloud server 400 from the store server 1 as described above, even if there is a response from the store server 1, a process according to the response is not performed. Therefore, the generation of the transaction data DAA described above is performed in the background.

For example, in a state where the access URL used for the newest access included in the history data DAB is selected, the processor 201 determines that the reproduction is completed in ACT 27, determines YES, and proceeds to ACT 28. In ACT 28, the processor 201 waits for the operation in the same manner as ACT 16 in FIG. 9. The customer can continuously perform various operations described above without being aware of the failure described above. Also, if any one operation to be received is performed, the processor 201 determines YES in ACT 28 and proceeds to ACT 29.

In ACT 29, the processor 201 requests the process according to the operation from the store server 1. Here, the process of the processor 201 is the same process as in ACT 17 in FIG. 9, but the access URL is generated including the basic URL indicated in the check-in data. Therefore, the processor 201 performs the information process based on the smartphone POS app APB, and thus a computer including the processor 201 as the central portion functions as a third request unit.

In the store server 1, if the access for the new request according to the operation is received in this manner, the processor 11 determines YES in ACT 63 in FIG. 12 and performs ACTS 64 and 65 in the same manner as described above. Accordingly, the processor 11 further updates the transaction data DAA according to the request that is not received by the cloud server 400. Therefore, the processor 11 performs the information process based on the proxy POS app APA, and thus a computer including the processor 11 as the central portion functions as a second processing unit and a second management unit.

If the transaction is completed, for example, if the settlement normally ends in ACT 64, the processor 11 determines YES in ACT 66 and proceeds to ACT 67. In ACT 67, the processor 11 notifies the transaction data DAA to the cloud server 400. The processor 11 transmits the notification data including the transaction data DAA to the cloud server 400 via the in-store communication network 5, the gateway 3, and the communication network 500. If the failure described above is not resolved yet, and the notification of the transaction data cannot be completed, the transmission of the notification data is repeated after a predetermined period of time. Otherwise, an API providing data indicating the operation state of the cloud server 400 is published by the cloud server 400, and the processor 11 may confirm the operation state of the cloud server 400 by using the API and transmit the notification data after confirming that the failure is resolved. Also, if the notification is completed, the processor 11 ends the proxy POS process. Therefore, the processor 11 performs the information process based on the proxy POS app APA, and thus a computer including the processor 11 as the central portion functions as a notification unit.

If the communication network 500 is the cause of the processor 201 in the user terminal 200 determining that the failure occurs in ACT 20 in FIG. 9, the processor 401 in the cloud server 400 continues the proxy POS process as it is, but the process request from the user terminal 200 is not performed, and thus the processor 401 is still in the waiting state of ACTS 46 and 47 in FIG. 11. In addition, if the processor 401 stops the proxy POS process being performed in response to the occurrence of some failure of its own device, the processor 401 is in the waiting state of ACTS 46 and 47 after the restoration from the corresponding failure. Therefore, if the notification data transmitted from the store server 1 is received by the communication interface 404 as described above, the processor 401 in the cloud server 400 is in the waiting state of ACTS 46 and 47. Also, in response to the reception of the notification data including the transaction code regarding the transaction to be the target in the corresponding proxy POS process, the processor 401 determines YES in ACT 47 and proceeds to ACT 51.

In ACT 51, the processor 401 updates the transaction data DAD based on the notification data. For example, the processor 401 selects the transaction data DAD including the transaction code included in the notification data from the transaction data DAD stored in the auxiliary storage unit 403. Also, the processor 401 rewrites all the merchandise data included in the corresponding transaction data DAD to the merchandise data in the notification data. Also, the processor 401 ends the proxy POS process accordingly. That is, the processor 401 updates the transaction data DAD to the data indicating the content of the transaction completed by the store server 1 by proxy. Therefore, the processor 401 performs the information process based on the web POS app APD, and thus a computer including the processor 401 as the central portion functions as an update unit.

If it is not required to store the transaction data DAD regarding the completed transaction in the cloud server 400, the processor 401 may delete the transaction data DAD including the transaction code included in the notification data from the auxiliary storage unit 403 in ACT 51. Otherwise, if journal data based on the transaction data DAD regarding the completed transaction is stored in the cloud server 400, if the processor 401 determines YES in ACT 50 or after ending ACT 51, the processor 401 may generate the journal data based on the transaction data DAD, store the journal data in the auxiliary storage unit 403, and delete the corresponding transaction data DAD.

In the user terminal 200, the processor 201 requests the process in ACT 29 in FIG. 10, and then proceeds to ACT 30. In ACT 30, the processor 201 waits for the response to the process requested in ACT 29. Also, if the response data transmitted from the store server 1 in ACT 65 in FIG. 12 is received by the mobile communication unit 209, the processor 11 determines YES and proceeds to ACT 31.

In ACT 31, the processor 201 performs the process according to the response from the store server 1. For example, if the response data including the data of the screen indicating the content of the changed transaction data is received, the processor 201 displays the corresponding screen on the touch panel 204. In ACT 32, the processor 201 confirms whether the transaction is completed. Also, for example, if the notification data for notifying the transaction completion is not included in the response data, the processor 201 determines NO and returns to the waiting state of ACT 28. Thereafter, the processor 201 repeatedly performs ACTS 29 to 31 whenever the operation is performed by the customer.

If the notification data for notifying the transaction completion is included in the response data received from the cloud server 400, the processor 201 determines YES in ACT 22 in FIG. 9. If the notification data for notifying the transaction completion is included in the response data received from the store server 1, the processor 201 determines YES in ACT 32 in FIG. 10. Then, the processor 201 returns to the waiting state of ACT 12 in FIG. 9 in any case.

As described above, the merchandise sales processing system holds the history of the request from the cloud server 400 in the user terminal 200, and causes the store server 1 to perform the process performed by the cloud server 400 based on the history by the request from the user terminal 200 in the circumstance where the cloud server 400 cannot perform the process due to the failure. Accordingly, a list of the merchandises to be purchased that are managed by the transaction data DAA in the store server 1 can be matched with a list of merchandises to be purchased that are managed by the transaction data DAD in the cloud server 400 if the failure occurs. Also, by causing the store server 1 to perform the subsequent processes, the process of the transaction can be continued by the store server 1 by proxy. Also, it is not required to cause the cloud server 400 and the store server 1 to cooperate with each other to match the transaction data DAA and the transaction data DAD, and the server can be easily switched if the failure occurs.

In the merchandise sales system, regarding the transaction interrupted by the store server 1 by proxy in the cloud server 400, after the interrupted transaction is completed by the store server 1, the result of the transaction is notified from the store server 1 to the cloud server 400. Also, the cloud server 400 can complete the interrupted transaction based on the notification.

According to the embodiment, various modifications as below can be made. The information processes performed by the cloud server 400 and the store server 1 are not limited to the information processes for the merchandise sales processes and may be any information processes.

For example, the cloud server 400 may be substituted with any other server device such as a server device installed in the headquarters that collectively manage a plurality of stores.

The store server 1 may be substituted with another server device provided in any facilities other than the store.

If the shopping is realized by using the cart terminal 300 instead of the user terminal 200, the user terminal 200 can be also read as the cart terminal 300. That is, the processor 302 of the cart terminal 300 may perform substantially the same information processes as those by the processor 201 of the user terminal 200. Here, in case of the cart terminal 300, the reading of the check-in data may be omitted, for example, by storing at least a part of various kinds of data indicated in the check-in data, in the main memory 303 or the auxiliary storage unit 304 in advance. In addition, the cart terminal 300 accesses the cloud server 400 via the access point 4, the in-store communication network 5, the gateway 3, and the communication network 500.

If the user terminal 200 is rented to the customer by the store, the reading of the check-in data may be omitted by storing at least a part of various kinds of data indicated in the check-in data in the main memory 202 or the auxiliary storage unit 203 in advance.

The process of the cloud server 400 or the process of the store server 1 may be performed by a plurality of server devices in a dispersed manner.

The request and the response of the store server 1 from and to the user terminal 200 and the cart terminal 300 may be relayed by another server device.

A part or all of the respective functions realized by the processors 11, 201, 302, and 401 by the information process can also be realized by hardware that performs the information processes that are not based on a program such as a logic circuit. Further, the above functions can be realized by combining software control with the above hardware such as the logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising a first server, a second server, and a client device, wherein:
the client device is configured to provide a plurality of first requests to the first server, each first request indicating that the first server should perform a first information process;
the first server is configured to perform the first information processes according to the first requests from the client device and record a first performance result of each first information process in association with an identifier, the identifier being the same for each first performance result;
the client device is configured to record a history of the first requests in correlation with the identifier;
the client device is configured to determine occurrence of a failure regarding the first server;
in response to determining that the failure has occurred, the client device is configured to (a) use the history to identify an incomplete information process that the client device requested for the first server to perform but that was not completed by the first server due to the failure and (b) provide a second request to the second server, the second request indicating that the second server should perform the incomplete information process, and the second request including the identifier;
the second server is configured to perform the incomplete information process according to the second request from the client device and record a second performance result of the incomplete information process in association with the identifier;
the second server is configured to provide a notification to the first server, the notification including the second performance result together with the identifier; and
in response to receiving the notification, the first server is configured to record the second performance result in association with the identifier.

2. The information processing system of claim 1, wherein:
the client device is configured to provide a third request to the second server and providing the second request, the third request indicating that the second server should perform a second information process;
the second server is configured to perform the second information process according to the third request from the client device and record a third performance result of the second information process in association with the identifier;
the second server is configured to provide the notification to the first server after the second information process is completed, and the notification includes the third performance result; and
in response to receiving the notification, the first server is configured to record the second performance result and the third performance result in association with the identifier.

3. The information processing system of claim 2, wherein the first server and the second server are each configured to perform information processes for registration of merchandise designated by the client device as merchandise to be purchased and settlement of a price of the merchandise that is registered to be purchased.

4. The information processing system of claim 2, wherein:
the first server is a cloud server; and
the second server is a local server provided in a facility in which an operation of the client device is performed.

5. The information processing system of claim 2, wherein:
a wide area network is used for communication between the client device and the first server; and
a narrow area network is used for communication between the client device and the second server.

6. The information processing system of claim 2, wherein the incomplete information process is a registration of a merchandise to be purchased.

7. The information processing system of claim 2, wherein the incomplete information process is a change of a quantity of merchandise that has been previously designated by the client device as merchandise to be purchased.

8. The information processing system of claim 2, wherein the incomplete information process is settlement of a price for merchandise that has been previously designated by the client device as merchandise to be purchased.

9. The information processing system of claim 2, wherein the failure regarding the first server is at least one of (a) a failure of the first server or (b) a failure of a network that facilitates communication between the client device and the first server.

10. The information processing system of claim 2, wherein the client device is a communication terminal coupled to a shopping cart.

11. The information processing system of claim 2, wherein the client device is a smartphone or a tablet computer.

12. A client device including a one or more processors and a memory containing instructions that, when executed by the one or more processors, cause the one or more processors to:
provide a first request to a first server, the first request indicating that the first server should perform a first information process;
record a history of the first request in correlation with an identifier;
determine occurrence of a failure regarding the first server; and
in response to determining that the failure has occurred, (a) use the history to identify an incomplete information process that the client device requested for the first server to perform but that was not completed by the first server and (b) provide a second request to a second server, the second request indicating that the second server should perform the incomplete information process, and the second request including the identifier.

13. The client device of claim 12, wherein the instructions cause the one or more processors to provide a third request to the second server after the second request ends, the third request indicating that the second server should perform a second information process.

14. The client device of claim 12, wherein the instructions cause the one or more processors to request for the first server and the second server to perform information processes for registration of merchandise designated by the client device as merchandise to be purchased and settlement of a price of the merchandise that is registered to be purchased.

15. The client device of claim 12, wherein:
the client device is configured to communicate with the first server through a wide area network, and
the client device is configured to communicate with the second server through a narrow area network.

16. An information processing method for causing a computer functioning as a client device to perform operations comprising:
providing a first request to a first server, the first request indicating that the first server should perform a first information process;
recording a history of the first request in correlation with an identifier;
determining occurrence of a failure regarding the first server; and
in response to determining that the failure has occurred, (a) using the history to identify an incomplete information process that the client device requested for the first server to perform but that was not completed by the first server and (b) providing a second request to a second server, the second request indicating that the second server should perform the incomplete information process, and the second request including the identifier.

17. The information processing method of claim 16, the operations further comprising providing a third request to the second server after the second request ends, the third request indicating that the second server should perform a second information process.

18. The information processing method of claim 17, further comprising requesting for the first server and the second server to perform information processes for registration of merchandise designated by the client device as merchandise to be purchased and settlement of a price of the merchandise that is registered to be purchased.

19. The information processing method of claim 17, wherein:
the client device is configured to communicate with the first server through a wide area network, and
the client device is configured to communicate with the second server through a narrow area network.

20. The information processing method of claim 17, wherein the failure regarding the first server is at least one of (a) a failure of the first server or (b) a failure of a network that facilitates communication between the client device and the first server.
